(19) United States
(12) Patent Application Publication
(10) Pub. No.: US 2015/0304274 A1
(43) Pub. Date: Oct. 22, 2015

(54) METHOD AND APPARATUS FOR CONFIGURING DHCP CLIENT

(71) Applicant: Wei ZHANG, Beijing (CN)

(72) Inventor: Wei ZHANG, Beijing (CN)

(73) Assignee: THOMSON LICENSING, Issy de Moulineaux (FR)

(21) Appl. No.: 14/423,600

(22) PCT Filed: Aug. 24, 2012
(86) PCT No.: PCT/CN2012/080566

§ 371 Date: Feb. 24, 2015

(51) Int. Cl. H04L 29/12; H04L 12/26; H04L 12/24

(52) U.S. Cl. CPC H04L 61/2015; H04L 41/0873; H04L 43/0811

(57) ABSTRACT

It is provided a method for configuring a DHCP client. The method comprises the steps of detecting state of the DHCP client; in response to transition to Bound state, storing network address and at least one of configuration parameters of the DHCP client, which is allocated by a DHCP server; and when the DHCP server is unreachable, in response to transition to Selecting state, restoring the network address and the at least one of configuration parameters without changing the Selecting state of the DHCP client.

### TECHNICAL FIELD

The present invention relates to data communication, and more particularly, relates to a method and an apparatus for configuring DHCP client.

### BACKGROUND

The Dynamic Host Configuration Protocol (DHCP) is a network protocol that is used to configure network devices so that they can communicate on an IP network. A DHCP client uses the DHCP protocol to acquire necessary client configuration parameters, including network address (normally, it's IP address), subnet mask, default gateway and one or more DNS server addresses etc. from a DHCP server. The DHCP client then uses these configuration parameters to configure its host. Once the configuration process is complete, the DHCP client is able to communicate on the IP network. Normally, the IP address is granted by the DHCP server to the DHCP client for a limited interval, which is called lease. It means that only in the lease the allocation of IP address is valid. Before the lease expires, the DHCP client is responsible for renewing its IP address; and, if it has not been able to renew it, it must stop using the address once the lease has expired

The DHCP server maintains the client configuration parameters for all potential DHCP clients, comprising a database of available IP addresses. When it receives a request from a DHCP client, the DHCP server determines the network to which the DHCP client is connected, and then allocates an IP address or prefix that is appropriate for the DHCP client, and sends client configuration parameter appropriate for that client including the allocated IP address or prefix.

Because the DHCP protocol must work correctly even before DHCP clients have been configured, the DHCP server and DHCP client must be connected to the same network link. In larger networks, this is not practical. In such networks, each network link contains one or more DHCP relay agents. These DHCP relay agents receive messages from DHCP clients and forward them to DHCP servers. DHCP servers send responses back to the relay agent, and the relay agent then sends these responses to the DHCP client on the local network link.

FIG. 1 is a diagram illustrating an example of an actual utilization of DHCP protocol according to prior art. A DHCP server and a DHCP client are connected via a router, and a Video on Demand (VoD) server is connected to the router through Internet. The client obtains necessary client configuration parameters from the DHCP server first, and then uses these parameters to communicate with the VoD server on the IP layer in order to get video content from it. However, sometimes, the DHCP server becomes unreachable so that the DHCP client cannot renew its lease, which will consequently affect the data service between the VoD server and the DHCP client. The reasons why the DHCP server is unreachable include the data link between the DHCP client and the DHCP server is broken (as FIG. 1 shows, the link between the DHCP server and the router is broken), the DHCP server is down etc.

Therefore, it's desirable not to affect the data service when the DHCP server becomes unreachable for lease renewal.

### SUMMARY

According to an aspect of the present invention, it is provided a method for configuring a DHCP client. The method comprises the steps of detecting state of the DHCP client; in response to transition to Bound state, storing network address and at least one of configuration parameters of the DHCP client, which is allocated by a DHCP server; and when the DHCP server is unreachable, in response to transition to Selecting state, restoring the network address and the at least one of configuration parameters without changing the Selecting state of the DHCP client.

According to another aspect of the present invention, it is provided a DHCP client apparatus. The DHCP client apparatus comprises a detecting module for detecting state of the DHCP client apparatus; and a configuring module for, in response to transition to Bound state storing network address and at least one of configuration parameters of the DHCP client, which is allocated by a DHCP server; and when the DHCP server is unreachable, in response to transition to Selecting state, restoring the network address and the at least one of configuration parameters without changing the Selecting state of the DHCP client.

It is to be understood that more aspects and advantages of the invention will be found in the following detailed description of the present invention.

### BRIEF DESCRIPTION OF THE DRAWINGS

The accompanying drawings, which are included to provide a further understanding of the present invention, illustrate embodiments of the invention together with the description which serves to explain the principle of the invention. Therefore, the invention is not limited to the embodiments. In the drawings:

FIG. 1 is a diagram illustrating an example of a practical utilization of DHCP protocol according to prior art;

FIG. 2 is a diagram illustrating finite state transition for DHCP client according to prior art.

FIG. 3 is a block diagram of DHCP client according to an embodiment of present invention. And

FIG. 4 is a flow chart illustrating a method for configuring DHCP client when the DHCP client fails to renew its lease according to the embodiment of present invention.

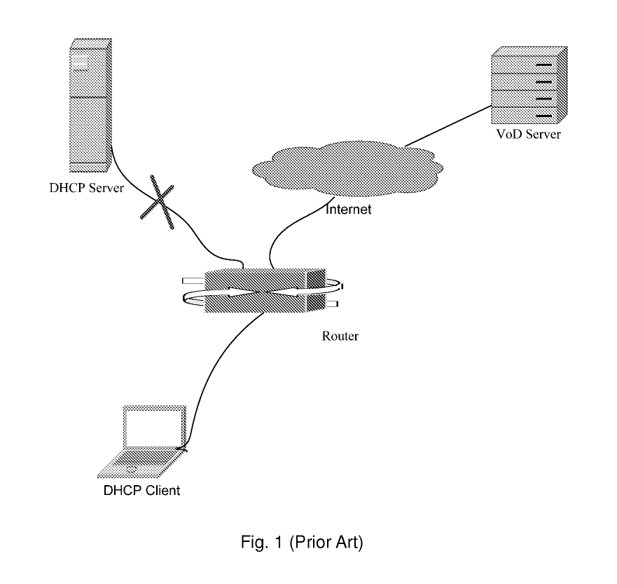

### DETAILED DESCRIPTION

An embodiment of the present invention will now be described in detail in conjunction with the drawings. In the following description, some detailed descriptions of known functions and configurations may be omitted for clarity and conciseness.

The principle of the present invention intends to provide a method for configuring a DHCP client when the DHCP client fails to renew the lease from a DHCP server, without the need of changing the existing DHCP protocols as defined mainly in RFC2131 (Dynamic Host Configuration Protocol), RFC2132 (DHCP Options and BOOTP Vendor Extensions) and RFC3046 (DHCP Relay Agent Information Option). It shall note besides RFC2132, other standard documents also describe DHCP Options, for example, RFC3004, RFC2610, RFC4039, RFC4702, RFC3046, RFC3442 etc. In other words, it means in order to deploy the principle of the present invention, it does not to modify the DHCP protocols in the DHCP server, and consequently the present invention can be easily deployed in the existing DHCP

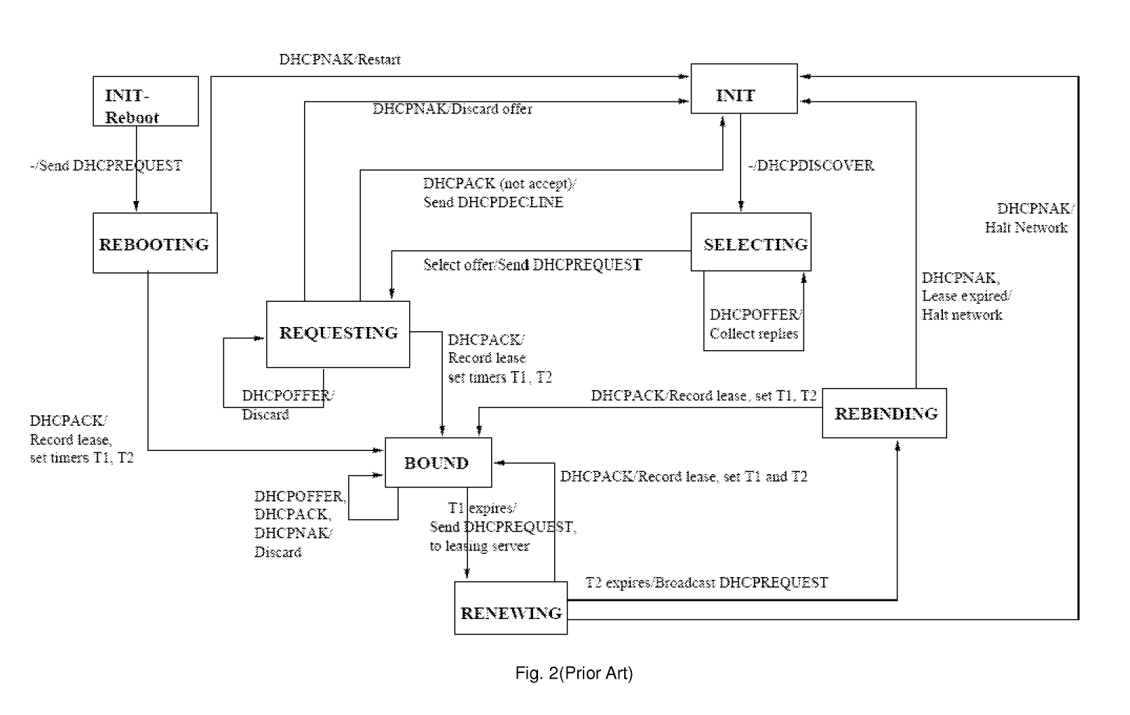

Before introducing the principle of the present invention, some description necessary for understanding the present invention is introduced with reference to the state-transition diagram for DHCP clients as defined in RFC2131. As can be seen from the FIG. 2, states for describing the lease life cycle from the perspective of the DHCP client include INIT-Reboot, REBOOTING, INIT, REQUESTING, SELECTING, BOUND, REBINDING and RENEWING. The DHCP client begins in an initial INIT state where it has no lease, and then transitions through various states as it acquires, renews, rebinds and/or releases the IP address allocated by the DHCP server to it. The table 1 below briefly shows states, events causing transitions to occur and transitions. More details can be found in RFC 2131.

TABLE 1
DHCP Client Finite State Machine

| State | State Description | Event and Transition |
|---|---|---|
| INIT | This is the initialization state, | Client Sends DHCPDISCOVER: |
| | where a client begins the | The client creates a |
| | process of acquiring a lease. It | DHCPDISCOVER message and |
| | also returns here when a lease | broadcasts it to try to find a DHCP |
| | ends, or when a lease | server. It transitions to the |
| | negotiation fails. | SELECTING state. |
| SELECTING | The client is waiting to receive | Client Receives Offers, Selects |
| | DHCPOFFER messages from | Preferred Offer, Sends |
| | one or more DHCP servers, so | DHCPREQUEST. The client |
| | it can choose one. | chooses one of the offers it has |
| | | been sent, and broadcasts a |
| | | DHCPREQUEST message to tell |
| | | DHCP servers what its choice was. |
| | | It transitions to the REQUESTING |
| | | state. |
| REQUESTING | The client is waiting to hear | Client Receives DHCPACK, |
| | back from the server to which it | Successfully Checks That IP |
| | sent its request. | Address Is Free: The client |
| | | receives a DHCPACK message |
| | | from its chosen server, confirming |
| | | that it can have the lease that was |
| | | offered. It checks to ensure that |
| | | address is not already used, and |
| | | assuming it is not, records the |
| | | parameters the server sent it, sets |
| | | the lease timers T1 and T2, and |
| | | transitions to the BOUND state. |
| | | Client Receives DHCPACK, But |
| | | IP Address Is In Use: The client |
| | | receives a DHCPACK message |
| | | from its chosen server, confirming |
| | | that it can have the lease that was |
| | | offered. However, it checks and |
| | | finds the address already in use. It |
| | | sends a DHCPDECLINE message |
| | | back to the server, and returns to |
| | | the INIT state. |
| | | Client Receives DHCPNAK: The |
| | | client receives a DHCPNAK |
| | | message from its chosen server, |
| | | which means the server has |
| | | withdrawn its offer. The client |
| | | returns to the INIT state. |
| INIT-REBOOT | When a client that already has | Client Sends DHCPREQUEST: |
| | a valid lease starts up after a | The client sends a |
| | power-down or reboot, it starts | DHCPREQUEST message to |
| | here instead of the INIT state. | attempt to verify its lease and re- |
| | | obtain its configuration parameters. |
| | | It then transitions to the |
| | | REBOOTING state to wait for a |
| | | response. |
| REBOOTING | A client that has rebooted with | Client Receives DHCPACK, |
| | an assigned address is waiting | Successfully Checks That IP |
| | for a confirming reply from a | Address Is Free: The client |
| | server. | receives a DHCPACK message |
| | | from the server that has its lease |
| | | information, confirming that the |
| | | lease is still valid. To be safe, the |
| | | client checks anyway to ensure |
| | | that the address is not already in |
| | | use by some other device. |
| | | Assuming it is not, the client |
| | | records the parameters the server |
| | | sent it and transitions to the |
| | | BOUND state. |
| | | Client Receives DHCPACK, But |
| | | IP Address Is In Use: The client |
| | | receives a DHCPACK message |
| | | from the server that had its lease, |
| | | confirming that the lease is still |
| | | valid. However, the client checks |
| | | and finds that while the client was |
| | | offline, some other device has |
| | | grabbed its leased IP address. The |
| | | client sends a DHCPDECLINE |
| | | message back to the server, and |
| | | returns to the INIT state to obtain a |
| | | new lease. |
| | | Client Receives DHCPNAK: The |
| | | client receives a DHCPNAK |
| | | message from a server. This tells it |
| | | that its current lease is no longer |
| | | valid; for example, the client may |
| | | have moved to a new network |
| | | where it can no longer use the |
| | | address in its present lease. The |
| | | client returns to the INIT state. |
| BOUND | Client has a valid lease and is | Renewal Timer (T1) Expires: The |
| | in its normal operating state. | client transitions to the RENEWING |
| | | state. |
| | | Client Terminates Lease, Sends |
| | | DHCPRELEASE: The client |
| | | decides to terminate the lease (due |
| | | to user command, for example.) It |
| | | sends a DHCPRELEASE message |
| | | and returns to the INIT state. |
| RENEWING | Client is trying to renew its | Client Receives DHCPACK: The |
| | lease. It regularly sends | client receives a DHCPACK reply |
| | DHCPREQUEST messages | to its DHCPREQUEST. Its lease is |
| | with the server that gave it its | renewed, it restarts the T1 and T2 |
| | current lease specified, and | timers, and returns to the BOUND |
| | waits for a reply. | state. |
| | | Client Receives DHCPNAK: The |
| | | server has refused to renew the |
| | | client's lease. The client goes to |
| | | the INIT state to get a new lease. |
| | | Rebinding Timer (T2) Expires: |
| | | While attempting to renew its |
| | | lease, the T2 timer expires, |
| | | indicating that the renewal period |
| | | has ended. The client transitions to |
| | | the REBINDING state. |
| REBINDING | The client has failed to renew | Client Receives DHCPACK: |
| | its lease with the server that | Some server on the network has |
| | originally granted it, and now | renewed the client's lease. The |
| | seeks a lease extension with | client binds to the new server |
| | any server that can hear it. It | granting the lease, restarts the T1 |
| | periodically sends | and T2 timers, and returns to the |
| | DHCPREQUEST messages | BOUND state. |
| | with no server specified until it | Client Receives DHCPNAK: A |
| | gets a reply or the lease ends. | server on the network is specifically |
| | | telling the client it needs to restart |
| | | the leasing process. This may be |
| | | the case if a new server is willing to |
| | | grant the client a lease, but only |
| | | with terms different than the client's |
| | | current lease. The client goes to |
| | | the INIT state. |
| | | Lease Expires: The client receives |
| | | no reply prior to the expiration of |
| | | the lease. It goes back to the INIT |
| | | state. |

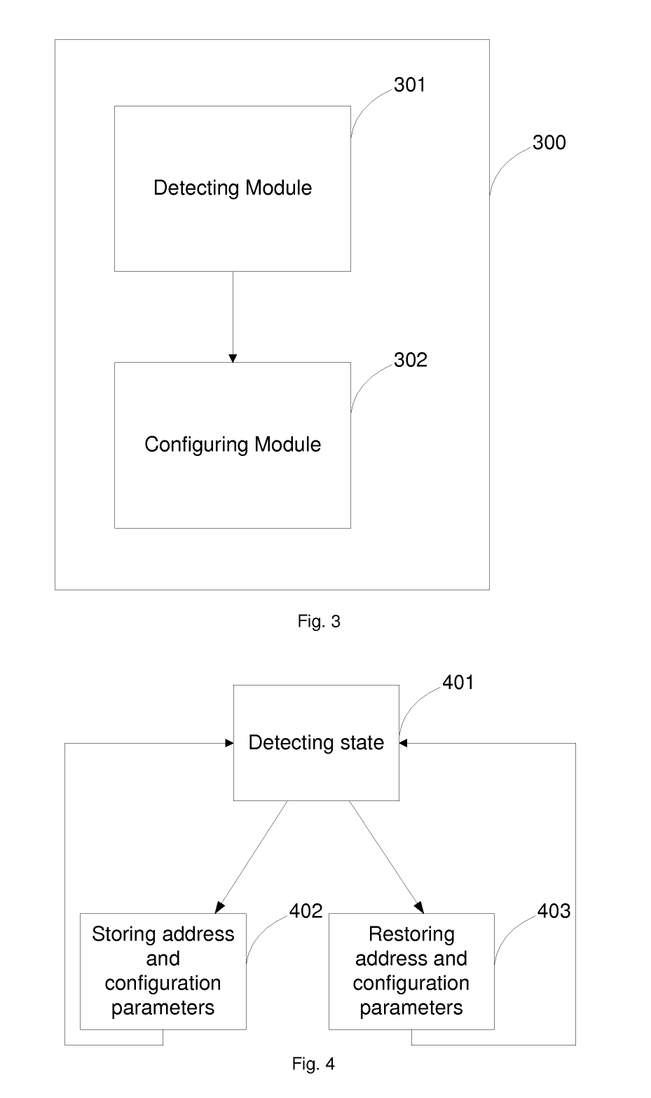

FIG. 3 is a block diagram of the DHCP client for configuring DHCP related configuration parameters according to an embodiment of present invention. The DHCP client 300 comprises a detecting module 301 and a configuring module 302. The detecting module 301 is adapted to detect or determine the current state of the DHCP client, and inform the configuring module 302 of the state. And the configuring module 302 is adapted to, in response to the state informed by the detecting module 301, perform configuration of the DHCP client. Specifically, in an embodiment of present invention which will be also described in detailed in conjunction with a method flow chart, the detecting module 301 is used to detect the states of Bound and Selecting of the DHCP client; and the configuring module 302 is used to 1) in response to the change to the Bound state, save and store the network address and other DHCP parameters as conveyed by DHCP server in DHCP options for configuring the DHCP client (which is defined in RFC 2132 DHCP Options and BOOTP Vendor Extensions); and 2) in response to change to the Selecting state, configure the DHCP client with the stored network address and other DHCP parameters. As a result, even if the DHCP client is at the state of Selecting, the DHCP client is still able to get itself configured so as to communicate with other data servers, e.g. VoD server. The merit is that the deployment of detecting module 301 and the configuring module 302 does not modify the DHCP protocols as used in the DHCP client. In other words, when the configuring module 302 configures the DHCP client with its stored network address and other DHCP parameters, it does not change the state of DHCP client. When the communication between the DHCP client and the DHCP server is restored, the DHCP client will transition from the Selecting state to the Bound state through Requesting state. The network address and other DHCP parameters as conveyed in the DHCP options by the DHCP server during the transition are used to configure the DHCP client, and consequently substitute the previous values as restored/configured by the configuring module 302.

It shall note the other DHCP parameters to be stored by the configuring module 302 vary with the purpose of the implementations by a person skilled in the art. The other DHCP parameters include subnet mask, router, domain name server, Network Time Protocol (NTP) server etc. In one embodiment, all DHCP parameters as conveyed by the DHCP server in the DHCP options of the DHCPOFFER message are stored in the state of Bound, and restored in the state of Selecting of the DHCP client. However, in other embodiment, only some DHCP parameters are stored in Bound state and restored in Selecting state. For example, the subnet mask, router, NTP server and domain name server are stored. In another variant embodiment, routing parameters that are used to generate routing entries in the routing table of the DHCP client is stored. In an exemplary embodiment, the routing parameters include tag 3 (Router) as defined in RFC2132 for DHCP Options, tag 33 (Static Route) as defined in RFC2132 for DHCP Options and tag 121 (Classless Static Route Option) as defined in RFC3442 for DHCP Options. Herein, as an example, each of the routing entries in the routing table consists of parameters of “Destination Prefix”, “Gateway IP”, “Interface ID” and “Route Metric”. An instance of a routing entry is “20.0.0.0/24”, “10.0.0.254”, “lan1”, “0”.

According to another embodiment of present invention, in order to address the potential IP address confliction after the DHCP client is configured at the state of Selecting, the configuring module 302 performs address confliction detection to detect if the address is used by other DHCP client or not. It can be implemented by sending ping packet to the network address that the DHCP client is using. If no response is received, it means the address is available to be used by the DHCP client. Or otherwise, the configuring module 302 will change the stored address, for example by increasing or decreasing the stored address with one step (e.g. 1) and repeat the address confliction detection until receiving no response.

FIG. 4 is a flow chart illustrating a method for configuring DHCP client when the DHCP client fails to renew its lease according to the embodiment of present invention.

In the step 401, after the DHCP client obtains network address and other configuration parameters from DHCP server for the first time, the detecting module 301 detects the state of the DHCP client by IPC (Interprocess communication) or socket. In a variant embodiment, the operation system level has a data field or a register to record the state of DHCP client. The detecting module can query from the data field or the register. In another variant embodiment, each time the state of DHCP client changes, the program process in charge of Finite State Machine of DHCP client notifies the detecting module of such change.

In the step 402, if it is detected the DHCP client is changed to the state of Bound, the configuring module 302 stores the network address and at least one of configuration parameters conveyed in the DHCP options by DHCP server. The configuration parameters include DNS server, NTP server, router, subnet mask. In a variant embodiment, the at least one of configuration parameters is routing parameters.

In the step 403, if it is detected the DHCP client is changed to the state of Selecting, the configuring module 302 restored the stored network address and the stored at least one of configuration parameters without changing the state of DHCP client.

In another embodiment of present invention, after restoring step 403, the configuring module 302 performs address confliction detection using the same approach as described above. If detecting confliction by receiving response, the configuring module 302 will change network address and then perform the restoring step 403 again.

Although the above embodiments are described in IP network, a person skilled in art shall know that the principle of present invention can also be used for the ADSL Modem, access routers, some device with high stability requirement (such as a PC Server).

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1-8. (canceled)

9. A method for configuring a DHCP client, comprising the steps of
detecting state of the DHCP client;
in response to transition to Bound state, storing network address and at least one of configuration parameters of the DHCP client, which is allocated by a DHCP server; and
when the DHCP server is unreachable, in response to transition to Selecting state, restoring the network address and the at least one of configuration parameters without changing the Selecting state of the DHCP client.

10. The method of the claim 9, further comprising
detecting whether the network address is used by other DHCP client or not by sending ping packet to the network address.

11. The method of the claim 10, further comprising
in response to detection that the network address is used by the other DHCP client, changing the network address and restoring the DHCP client with the changed network address.

12. The method of the claim 9, wherein, the configuration parameters comprises routing parameters, NTP server, DNS server, subnet mask.

13. The method of the claim 9, further comprising
When communication between the DHCP client and the DHCP server is restored from the unreachable, changing from the Selecting state to the Bound state.

14. A DHCP client apparatus, comprising
a detecting module for detecting state of the DHCP client apparatus; and
a configuring module for, in response to transition to Bound state storing network address and at least one of configuration parameters of the DHCP client, which is allocated by a DHCP server; and
when the DHCP server is unreachable in response to transition to Selecting state, restoring the network address and the at least one of configuration parameters without changing the Selecting state of the DHCP client.

15. The apparatus of the claim 14, wherein,
the configuration module is further configured to detect whether the network address is used by other DHCP client or not.

16. The apparatus of the claim 15, wherein the configuration module is further configured to in response to detection that the network address is used by the other DHCP client, change the network address and restore the DHCP client with the changed network address.

17. The apparatus of the claim 14, wherein, the configuration parameters comprises routing parameters, NTP server, DNS server, subnet mask.

18. The apparatus of the claim 14, wherein, the configuration module is further configured to, when communication between the DHCP client and the DHCP server is restored from the unreachable, change from the Selecting state to the Bound state.
